(19) United States
(12) Patent Application Publication
(10) Pub. No.: US 2011/0312211 A1
(43) Pub. Date: Dec. 22, 2011

(54) STRAIN RELIEF ACCESSORY FOR COAXIAL CABLE CONNECTOR

(75) Inventor: Christopher Philip Natoli, Fulton, NY (US)

(73) Assignee: JOHN MEZZALINGUA ASSOCIATES, INC., East Syracuse, NY (US)

(21) Appl. No.: 12/889,990

(22) Filed: Sep. 24, 2010

Related U.S. Application Data
(60) Provisional application No. 61/357,444, filed on Jun. 22, 2010.
(60) Provisional application No. 61/357,460, filed on Jun. 22, 2010.

(51) Int. Cl. H01R 13/58

(52) U.S. Cl. 439/460

(57) ABSTRACT

A strain relief accessory for a coaxial cable connector. In one example embodiment, a strain relief accessory for a coaxial cable connector includes a clamp sleeve and a strain relief clamp. The clamp sleeve is configured to surround a coaxial cable and attach to the rear end of a coaxial cable connector. The strain relief clamp is positioned within the clamp sleeve and is configured to exert an inwardly-directed radial force against the coaxial cable.

### CROSS-REFERENCE TO A RELATED APPLICATION

This application claims the benefit of U.S. Provisional Patent Application Ser. No. 61/357,444, filed on Jun. 22, 2010, and of U.S. Provisional Patent Application Ser. No. 61/357,460, filed on Jun. 22, 2010, each of which is incorporated herein by reference in its entirety.

### BACKGROUND

Coaxial cable is used to transmit radio frequency (RF) signals in various applications, such as connecting radio transmitters and receivers with their antennas. Coaxial cable typically includes an inner conductor, an insulating layer surrounding the inner conductor, an outer conductor surrounding the insulating layer, and a protective jacket surrounding the outer conductor.

Prior to installation, the two ends of a coaxial cable are generally terminated with a connector. Connectors can generally be classified as either field-installable connectors or factory-installed connectors. While portions of factory-installed connectors are generally soldered or welded to the conductors of the coaxial cable, field-installable connectors are generally attached to the conductors of the coaxial cable via compression delivered by a screw mechanism or a compression tool.

One difficulty with field-installable connectors, such as compression connectors or screw-together connectors, is maintaining acceptable levels of passive intermodulation (PIM). PIM in the terminal sections of a coaxial cable can result from nonlinear and insecure contact between surfaces of various components of the connector. A nonlinear contact between two or more of these surfaces can cause micro arcing or corona discharge between the surfaces, which can result in the creation of interfering RF signals.

For example, some screw-together connectors are designed such that the contact force between the connector and the outer conductor is dependent on a continuing axial holding force of threaded components of the connector. Over time, the threaded components of the connector can inadvertently separate, thus resulting in nonlinear and insecure contact between the connector and the outer conductor.

Further, even relatively secure contact between the connector and the outer conductor of the coaxial cable can be undermined as the coaxial cable is subject to stress, due to high wind or vibration for example, which can result in unacceptably high levels of PIM in terminal sections of the coaxial cable.

Where the coaxial cable is employed on a cellular communications tower, for example, unacceptably high levels of PIM in terminal sections of the coaxial cable and resulting interfering RF signals can disrupt communication between sensitive receiver and transmitter equipment on the tower and lower-powered cellular devices. Disrupted communication can result in dropped calls or severely limited data rates, for example, which can result in dissatisfied customers and customer churn.

Current attempts to solve these difficulties with field-installable connectors generally consist of employing a pre-fabricated jumper cable having a standard length and having factory-installed connectors that are soldered or welded on either end. These soldered or welded connectors generally exhibit stable PIM performance over a wider range of dynamic conditions than current field-installable connectors. These pre-fabricated jumper cables are inconvenient, however, in many applications.

For example, each particular cellular communications tower in a cellular network generally requires various custom lengths of coaxial cable, necessitating the selection of various standard-length jumper cables that is each generally longer than needed, resulting in wasted cable. Also, employing a longer length of cable than is needed results in increased insertion loss in the cable. Further, excessive cable length takes up more space on or around the tower. Moreover, it can be inconvenient for an installation technician to have several lengths of jumper cable on hand instead of a single roll of cable that can be cut to the needed length. Also, factory testing of factory-installed soldered or welded connectors for compliance with impedance matching and PIM standards often reveals a relatively high percentage of non-compliant connectors. This percentage of non-compliant, and therefore unusable, connectors can be as high as about ten percent of the connectors in some manufacturing situations. For all these reasons, employing factory-installed soldered or welded connectors on standard-length jumper cables to solve the above-noted difficulties with field-installable connectors is not an ideal solution.

### SUMMARY OF SOME EXAMPLE EMBODIMENTS

In general, example embodiments of the present invention relate to a strain relief accessory for a coaxial cable connector. The example strain relief accessory disclosed herein improves mechanical and electrical contacts in coaxial cable terminations, which reduces passive intermodulation (PIM) levels and associated creation of interfering RF signals that emanate from the coaxial cable terminations.

In one example embodiment, a strain relief accessory for a coaxial cable connector includes a clamp sleeve and a strain relief clamp. The clamp sleeve is configured to surround a coaxial cable and attach to the rear end of a coaxial cable connector. The strain relief clamp is positioned within the clamp sleeve and is configured to exert an inwardly-directed radial force against the coaxial cable.

In another example embodiment, a strain relief accessory for a coaxial cable connector includes a clamp sleeve, a strain relief clamp, and a clamp retention sleeve. The clamp sleeve is configured to surround a coaxial cable and attach to the rear end of a coaxial cable connector. The strain relief clamp is positioned within the clamp sleeve and is configured to exert an inwardly-directed radial force against the coaxial cable. The clamp retention ring is configured to retain the strain relief clamp within the clamp sleeve.

In yet another example embodiment, a coaxial cable connector assembly for terminating a coaxial cable is provided. The coaxial cable includes an inner conductor, an insulating layer surrounding the inner conductor, an outer conductor surrounding the insulating layer, and a jacket surrounding the outer conductor. The coaxial cable connector assembly includes a coaxial cable connector and a strain relief accessory. The coaxial cable connector includes an inner conductor clamp, an outer conductor clamp, and a moisture seal. The inner conductor clamp is configured to engage the inner conductor. The outer conductor clamp is configured to compress the outer conductor against an internal support structure. The moisture seal is configured to engage the jacket. The strain relief accessory includes a strain relief clamp configured to engage the coaxial cable. The strain relief clamp does not surround any portion of the internal support structure.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example corrugated coaxial cable terminated on one end with an example compression connector and an example strain relief accessory and prepared for termination on the other end with an identical compression connector and an identical strain relief accessory;

FIG. 1B is a perspective view of a portion of the example corrugated coaxial cable of FIG. 1A, the perspective view having portions of each layer of the example corrugated coaxial cable cut away;

FIG. 1C is a cross-sectional side view of a terminal end of the example corrugated coaxial cable of FIG. 1A after having been prepared for termination with the example compression connector and the example strain relief accessory of FIG. 1A;

FIG. 2A is a perspective view of the example compression connector and the example strain relief accessory of FIG. 1A, with the example compression connector and the example strain relief accessory being in open positions;

FIG. 2B is an exploded view of the example compression connector and the example strain relief accessory of FIG. 2A;

FIG. 2C is a cross-sectional side view of the terminal end of the example corrugated coaxial cable of FIG. 1C after having been inserted through the example strain relief accessory of FIG. 2A and into the example compression connector of FIG. 2A, with the example compression connector and the example strain relief accessory being in open positions;

FIG. 2D is a cross-sectional side view of the terminal end of the example corrugated coaxial cable of FIG. 1C after having been inserted through the example strain relief accessory of FIG. 2A and into the example compression connector of FIG. 2A, with the example compression connector having been moved, during the first stage of a two-stage compression process, into an engaged position;

FIG. 2E is a cross-sectional side view of the terminal end of the example corrugated coaxial cable of FIG. 1C after having been inserted through the example strain relief accessory of FIG. 2A and into the example compression connector of FIG. 2A, with the example strain relief accessory having been moved, during the second stage of the two-stage compression process, into an engaged position;

FIG. 3A is a perspective view of the example compression connector of FIG. 2A and an exploded view of a first alternative strain relief accessory;

FIG. 3B is a cross-sectional side view of the terminal end of the example corrugated coaxial cable of FIG. 1C after having been inserted through the first alternative strain relief accessory of FIG. 3A and into the example compression connector of FIG. 3A, with the example compression connector having been moved, during the first stage of a two-stage compression process, into an engaged position;

FIG. 3C is a cross-sectional side view of the terminal end of the example corrugated coaxial cable of FIG. 1C after having been inserted through the first alternative strain relief accessory of FIG. 3A and into the example compression connector of FIG. 3A, with the first alternative strain relief accessory having been moved, during the second stage of the two-stage compression process, into an engaged position;

FIG. 4A is a perspective view of the example compression connector of FIG. 2A and an exploded view of a second alternative strain relief accessory;

FIG. 4B is a cross-sectional side view of the terminal end of the example corrugated coaxial cable of FIG. 1C after having been inserted through the second alternative strain relief accessory of FIG. 4A and into the example compression connector of FIG. 4A, with the example compression connector having been moved, during the first stage of a two-stage compression process, into an engaged position; and

FIG. 4C is a cross-sectional side view of the terminal end of the example corrugated coaxial cable of FIG. 1C after having been inserted through the second alternative strain relief accessory of FIG. 4A and into the example compression connector of FIG. 4A, with the second alternative strain relief accessory having been moved, during the second stage of the two-stage compression process, into an engaged position.

### DETAILED DESCRIPTION OF SOME EXAMPLE EMBODIMENTS

Example embodiments of the present invention relate to a strain relief accessory for a coaxial cable connector. The example strain relief accessory disclosed herein improves mechanical and electrical contacts in coaxial cable terminations, which reduces passive intermodulation (PIM) levels and associated creation of interfering RF signals that emanate from the coaxial cable terminations.

In the following detailed description of some example embodiments, reference will now be made in detail to example embodiments of the present invention which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Coaxial Cable and Example Compression Connector Assembly

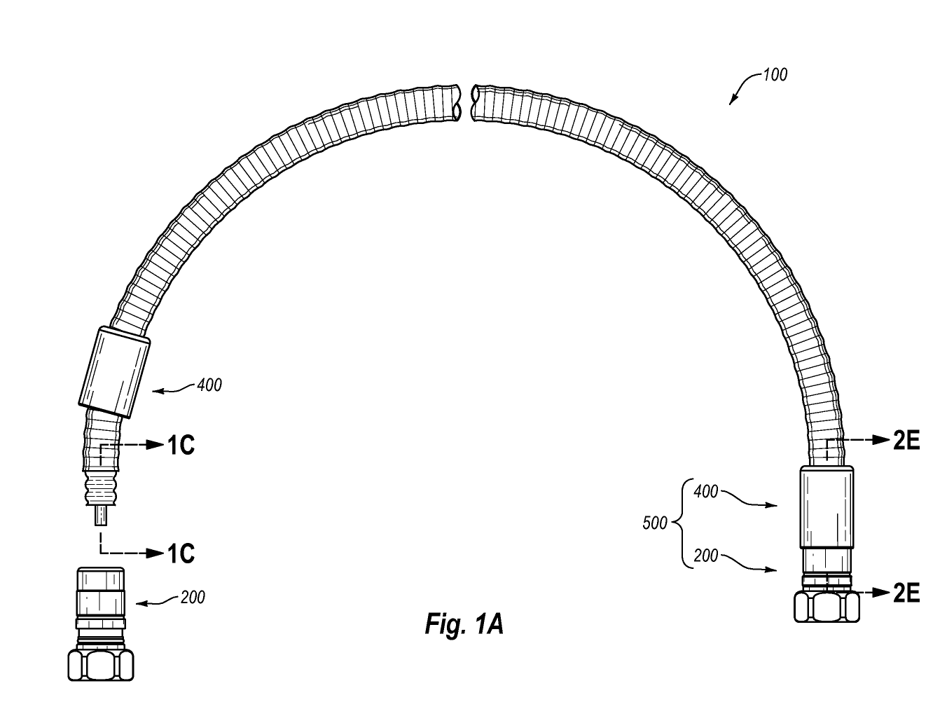

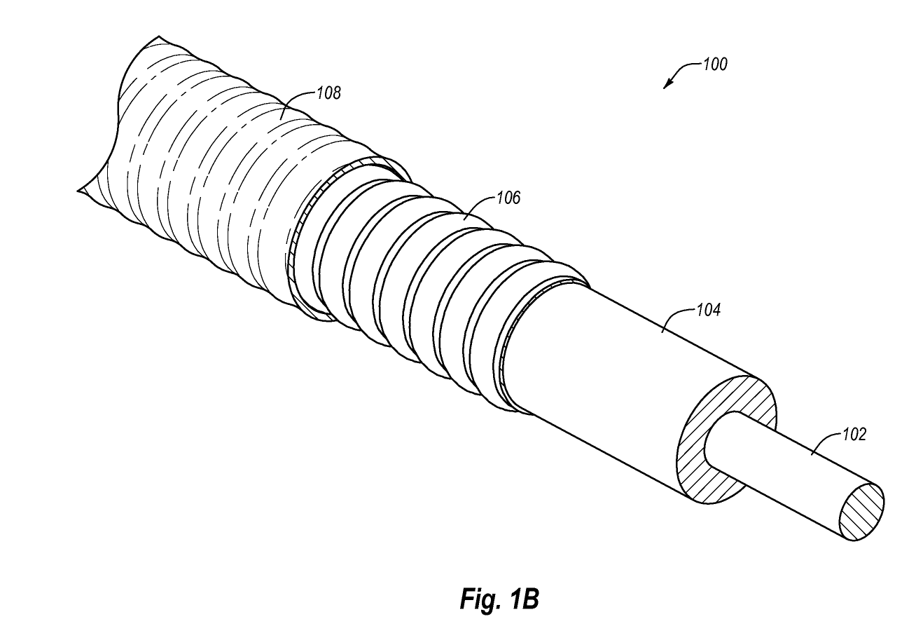

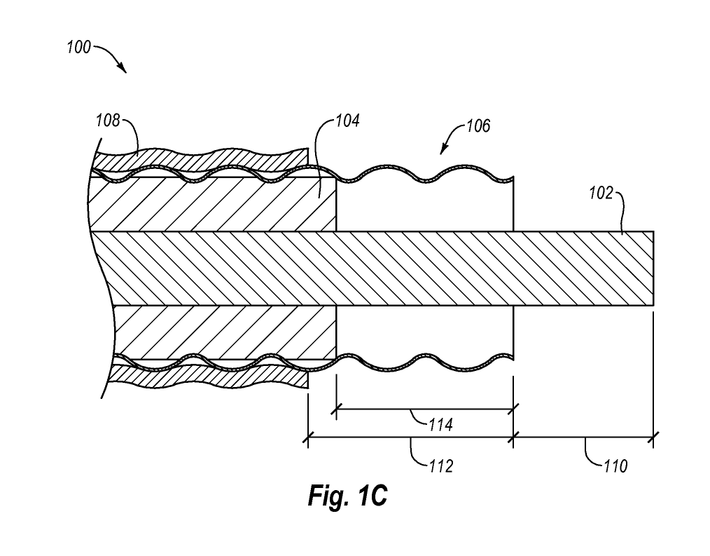

With reference now to FIG. 1A, an example coaxial cable 100 is disclosed. The example coaxial cable 100 has 50 Ohms of impedance and is a ½″ series corrugated coaxial cable. It is understood, however, that these cable characteristics are example characteristics only, and that the example compression connectors disclosed herein can also benefit coaxial cables with other impedance, dimension, and shape characteristics.

Also disclosed in FIG. 1A, the example coaxial cable 100 is prepared for termination on the left side of FIG. 1A with an example compression connector 200 and an example strain relief accessory 400. Although the example compression connector 200 is disclosed in FIG. 1A as a male compression connector, it is understood that the compression connector 200 can instead be configured as a female compression connector (not shown). The example coaxial cable 100 is terminated on the right side of FIG. 1A with an identical compression connector 200 and an identical strain relief accessory 400, which together comprise an example compression connector assembly 500.

With reference now to FIG. 1B, the coaxial cable 100 generally includes an inner conductor 102 surrounded by an insulating layer 104, an outer conductor 106 surrounding the insulating layer 104, and a jacket 108 surrounding the outer conductor 106. As used herein, the phrase “surrounded by” refers to an inner layer generally being encased by an outer layer. However, it is understood that an inner layer may be “surrounded by” an outer layer without the inner layer being immediately adjacent to the outer layer. The term “surrounded by” thus allows for the possibility of intervening layers. Each of these components of the example coaxial cable 100 will now be discussed in turn.

The inner conductor 102 is positioned at the core of the example coaxial cable 100 and may be configured to carry a range of electrical current (amperes) and/or RF/electronic digital signals. The inner conductor 102 can be formed from copper, copper-clad aluminum (CCA), copper-clad steel (CCS), or silver-coated copper-clad steel (SCCCS), although other conductive materials are also possible. For example, the inner conductor 102 can be formed from any type of conductive metal or alloy. In addition, although the inner conductor 102 of FIG. 1B is clad, it could instead have other configurations such as solid, stranded, corrugated, plated, or hollow, for example.

The insulating layer 104 surrounds the inner conductor 102, and generally serves to support the inner conductor 102 and insulate the inner conductor 102 from the outer conductor 106. Although not shown in the figures, a bonding agent, such as a polymer, may be employed to bond the insulating layer 104 to the inner conductor 102. As disclosed in FIG. 1B, the insulating layer 104 is formed from a foamed material such as, but not limited to, a foamed polymer or fluoropolymer. For example, the insulating layer 104 can be formed from foamed polyethylene.

Although not shown in the figures, it is understood that the insulating layer 104 can be formed from other types of insulating materials or structures having a dielectric constant that is sufficient to insulate the inner conductor 102 from the outer conductor 106. For example, an alternative insulating layer may be composed of a spiral-shaped spacer that enables the inner conductor 102 to be generally separated from the outer conductor 106 by air. The spiral-shaped spacer of the alternative insulating layer may be formed from polyethylene or polypropylene, for example. The combined dielectric constant of the spiral-shaped spacer and the air in the alternative insulating layer would be sufficient to insulate the inner conductor 102 from the outer conductor 106.

The outer conductor 106 surrounds the insulating layer 104, and generally serves to minimize the ingress and egress of high frequency electromagnetic radiation to/from the inner conductor 102. In some applications, high frequency electromagnetic radiation is radiation with a frequency that is greater than or equal to about 50 MHz. The outer conductor 106 can be formed from solid copper, solid aluminum, or copper-clad aluminum (CCA), although other conductive materials are also possible. The corrugated configuration of the outer conductor 106, with peaks and valleys, enables the coaxial cable 100 to be flexed more easily than cables with smooth-walled outer conductors. In addition, it is understood that the corrugations of the outer conductor 106 can be either annular, as disclosed in the figures, or can be helical (not shown).

The jacket 108 surrounds the outer conductor 106, and generally serves to protect the internal components of the coaxial cable 100 from external contaminants, such as dust, moisture, and oils, for example. In a typical embodiment, the jacket 108 also functions to limit the bending radius of the cable to prevent kinking, and functions to protect the cable (and its internal components) from being crushed or otherwise misshapen from an external force. The jacket 108 can be formed from a variety of materials including, but not limited to, polyethylene, high-density polyethylene, low-density polyethylene, linear low-density polyethylene, rubberized polyvinyl chloride, or some combination thereof. The actual material used in the formation of the jacket 108 might be indicated by the particular application/environment contemplated.

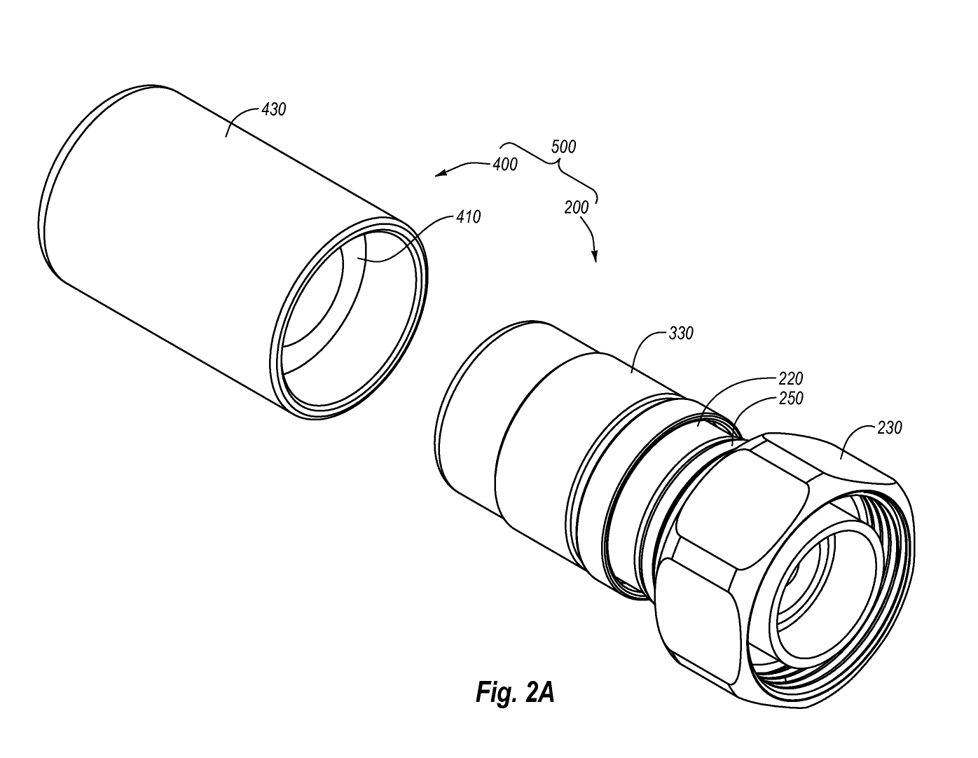

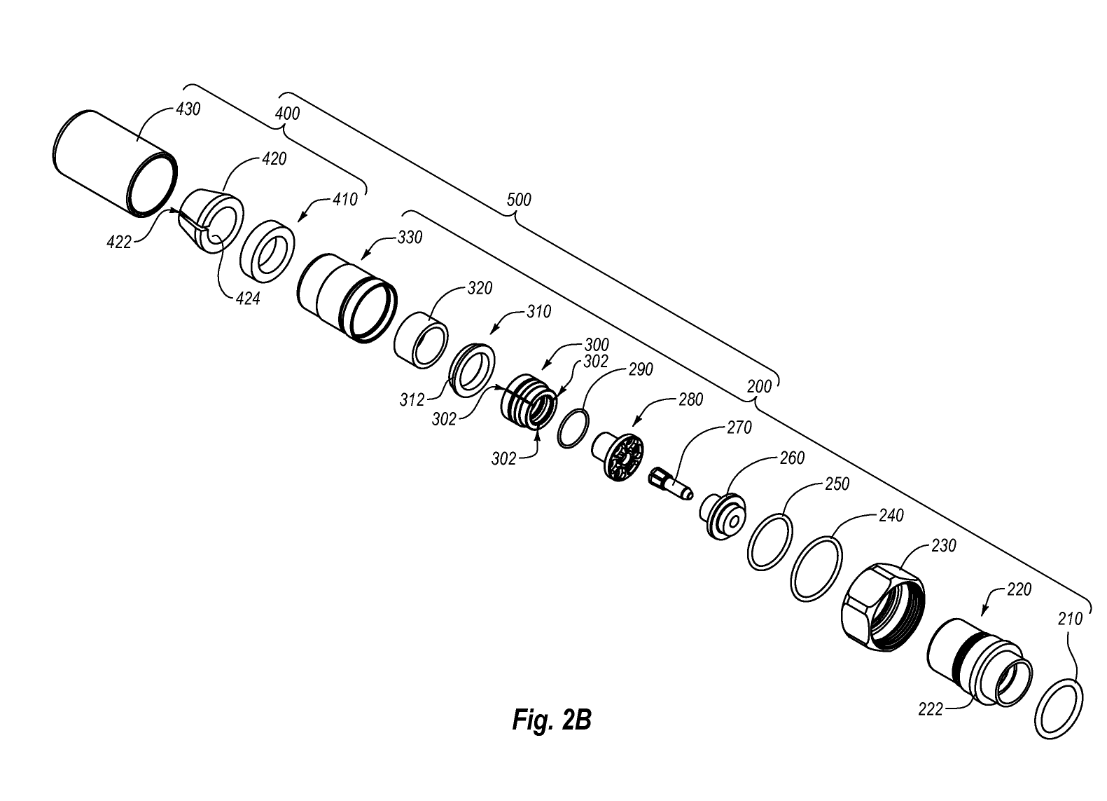

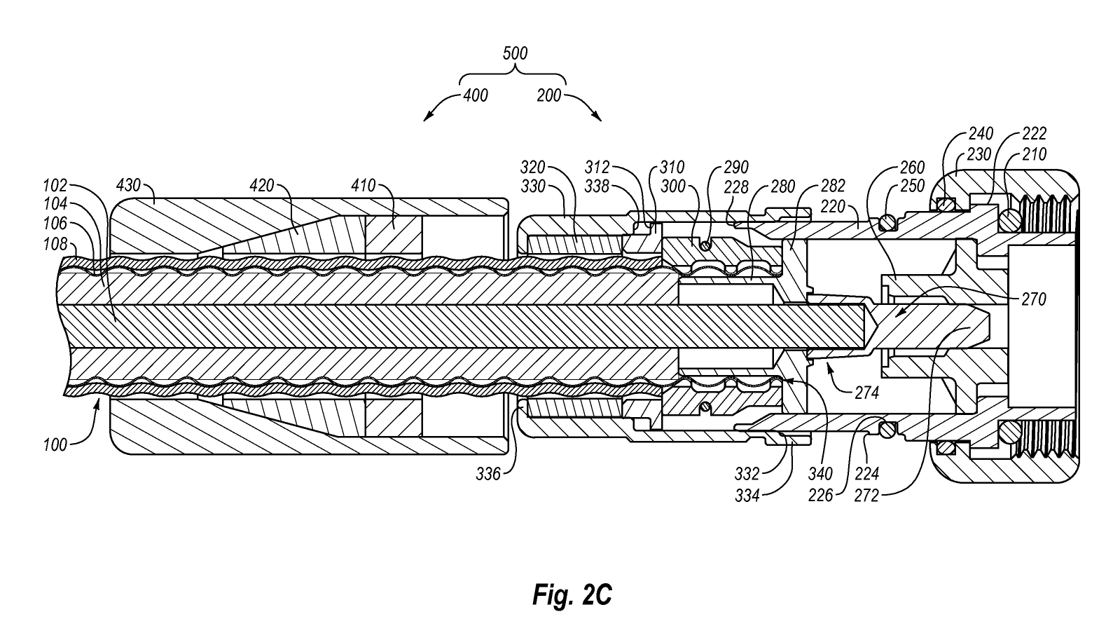

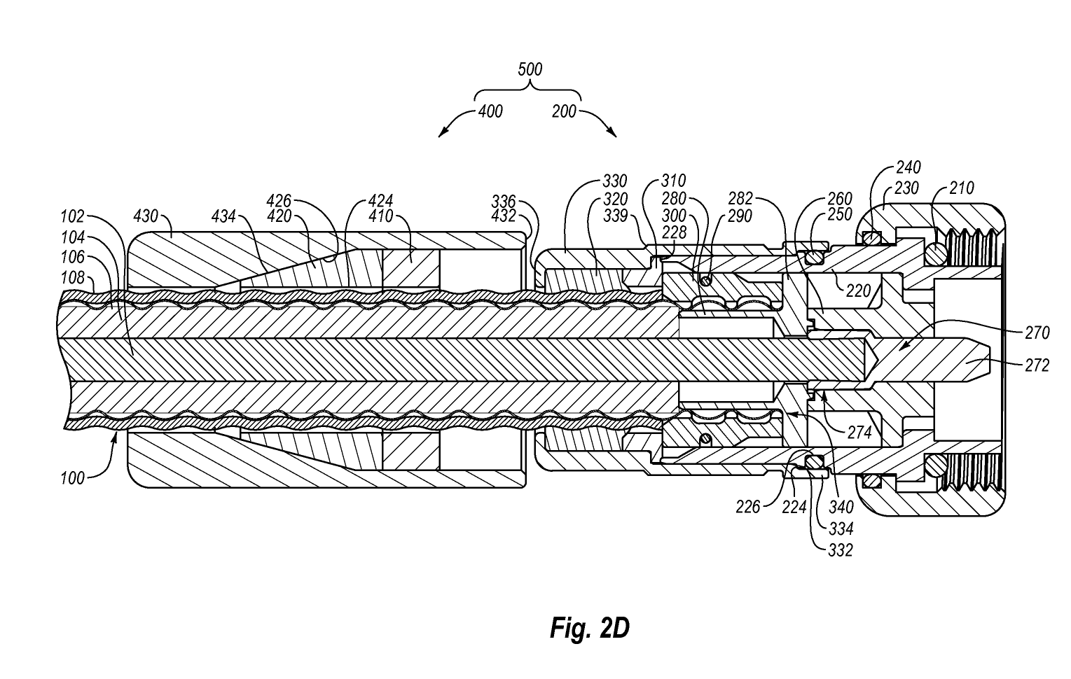

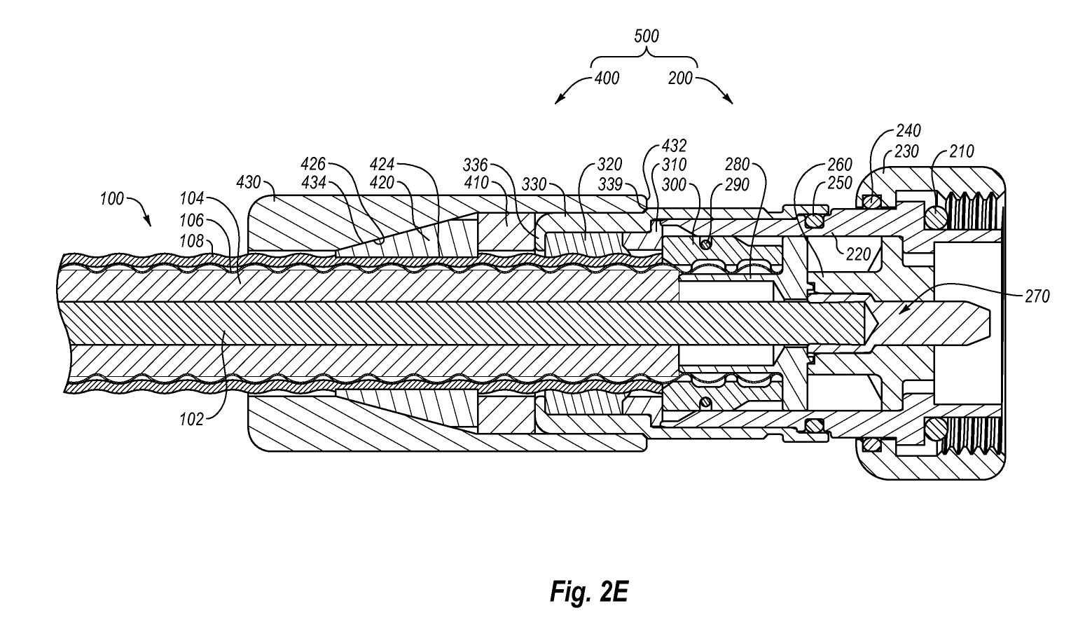

With reference to FIG. 1C, a terminal end of the coaxial cable 100 is disclosed after having been prepared for termination with the example compression connector 200, disclosed in FIGS. 1A and 2A-2D. As disclosed in FIG. 1C, the terminal end of the coaxial cable 100 includes a first section 110, a second section 112, and a cored-out section 114. The jacket 108, outer conductor 106, and insulating layer 104 have been stripped away from the first section 110. The jacket 108 has been stripped away from the second section 112. The insulating layer 104 has been cored out from the cored-out section 114.

### II. Example Compression Connector Assembly

With reference now to FIGS. 2A-2D, additional aspects of the example compression connector assembly 500 are disclosed. As noted above, the example compression connector assembly 500 includes the example compression connector 200 and the example strain relief accessory 400.

As disclosed in FIGS. 2A-2B, the example compression connector 200 includes a first o-ring seal 210, a connector body 220, a connector nut 230, a second o-ring seal 240, a third o-ring seal 250, an insulator 260, a conductive pin 270, a mandrel 280, a band 290, a clamp 300, a moisture seal ring 310, a moisture seal 320, and a compression sleeve 330. The example strain relief accessory 400 includes a clamp retention ring 410, a strain relief clamp 420, and a clamp sleeve 430.

As disclosed in FIG. 2B, the clamp 300 includes multiple pieces that cooperate to define slots 302 separating the pieces. Similarly, the strain relief clamp 420 defines a slot 422 running the length of the strain relief clamp 420. The strain relief clamp 420 also defines an engagement surface 424.

As disclosed in FIG. 2C, the connector nut 230 is connected to the connector body 220 via an annular flange 222. The insulator 260 positions and holds the conductive pin 270 within the connector body 220. The conductive pin 270 includes a pin portion 272 at one end and a clamp portion 274 at the other end. The mandrel 280 is positioned inside the connector body 220 next to the clamp portion 274 of the conductive pin 270. A driver portion 282 of the mandrel 280 also abuts the clamp 300. A band 290 surrounds the clamp 300 to hold the multiple pieces of the clamp 300 together. The clamp 300 abuts the moisture seal ring 310. The moisture seal ring 310 abuts the moisture seal 320, both of which are positioned within the compression sleeve 330.

Also disclosed in FIG. 2C, the clamp retention ring 410 and the strain relief clamp 420 are both positioned within the clamp sleeve 430. In at least some example embodiments, the clamp retention ring 410 engages an inside surface of the clamp sleeve 430 via an interference fit, for example. This engagement of the inside surface of the clamp sleeve 430 by the clamp retention ring 410 can help retain the strain relief clamp 420 within the clamp sleeve 430.

With reference now to FIGS. 2C-2E, additional aspects of the operation of the example compression connector assembly 500 are disclosed. FIG. 2C discloses the example compression connector 200 and the example strain relief accessory 400 in initial open positions. FIG. 2D discloses the example compression connector 200 after having been moved, during the first stage of a two-stage compression process, into an engaged position. FIG. 2E discloses the example strain relief accessory 400 after having been moved, during the second stage of the two-stage compression process, into an engaged position.

As disclosed in FIG. 2C, the terminal end of the coaxial cable 100 of FIG. 1C can be inserted through the example strain relief accessory 400 and into the example compression connector 200. Once inserted, the outer conductor 106 is received into the gap 340 defined between the mandrel 280 and the clamp 300. Also, once inserted, the inner conductor 102 is received into the clamp portion 274 of the conductive pin 270 such that the conductive pin 270 is mechanically and electrically contacting the inner conductor 102. Further, once inserted, the strain relief clamp 420 and the moisture seal 320 surround the jacket 108 of the coaxial cable 100.

As disclosed in FIGS. 2C and 2D, during the first stage of a two-stage compression process, the example compression connector 200 is moved into the engaged position by sliding the compression sleeve 330 axially along the connector body 220 toward the connector nut 230 until a shoulder 332 of the compression sleeve 330 abuts a shoulder 224 of the connector body 220. In addition, a distal end 334 of the compression sleeve 330 compresses the third o-ring seal 250 into an annular groove 226 defined in the connector body 220, thus sealing the compression sleeve 330 to the connector body 220.

Further, as the compression connector 200 is moved into the engaged position during the first stage of the two-stage compression process, a flange 336 of the compression sleeve 330 axially biases against the moisture seal 320, which axially biases against the moisture seal ring 310, which axially forces the clamp 300 into the smaller-diameter connector body 220, which radially compresses the clamp 300 around the outer conductor 106 by narrowing or closing the slots 302 (see FIG. 2B). The compression of the clamp 300 radially compresses the outer conductor 106 between the clamp 300 and the mandrel 280. The mandrel 280 is therefore an example of an internal connector structure as at least a portion of the mandrel 280 is configured to be positioned internal to the coaxial cable 100.

In addition, as the compression connector 200 is moved into the engaged position during the first stage of the two-stage compression process, the clamp 300 axially biases against the driver portion 282, which axially forces the clamp portion 274 of the conductive pin 270 into the smaller-diameter insulator 260, which radially compresses the clamp portion 274 around the inner conductor 102. Further, the pin portion 272 of the conductive pin 270 extends past the insulator 260 in order to engage a corresponding conductor of a female connector (not shown) once engaged with the connector nut 220.

Also, as the compression connector 200 is moved into the engaged position during the first stage of the two-stage compression process, the distal end 228 of the connector body 220 axially biases against the moisture seal ring 310, which axially biases against the moisture seal 320 until a shoulder 312 of the moisture seal ring 330 abuts a shoulder 338 of the compression sleeve 330, thereby axially compressing the moisture seal 320 causing the moisture seal 320 to become shorter in length and thicker in width. The thickened width of the moisture seal 320 causes the moisture seal 320 to exert a first inwardly-directed radial force against the jacket 108 of the coaxial cable 100, thus sealing the compression sleeve 330 to the jacket 108 of the coaxial cable 100.

As disclosed in FIGS. 2D and 2E, during the second stage of the two-stage compression process, the example strain relief accessory 400 is moved into the engaged position by sliding the clamp sleeve 430 axially along the compression sleeve 330 toward the connector nut 230 until the distal end 432 of the clamp sleeve 430 abuts a shoulder 339 of the compression sleeve 330.

Further, as the example strain relief accessory 400 is moved into the engaged position during the second stage of the two-stage compression process, a tapered surface 434 of the clamp sleeve 430 biases against a corresponding tapered surface 426 of the strain relief clamp 420, which biases against, and is in direct physical contact with, the clamp retention ring 410 until the clamp retention ring abuts, and is in direct physical contact with, the compression sleeve 330. The axial force of the clamp retention ring 410 combined with the opposite axial force of the clamp sleeve 430 forces the tapered surface 426 of the strain relief clamp 420 to interact with the corresponding tapered surface 434 of the strain relief ring 430 in order to exert a second inwardly-directed radial force against the jacket 108 by narrowing or closing the slot 422 (see FIG. 2B). The tapered surface 426 of the strain relief clamp 420 tapers inwardly away from the example compression connector 200. It is noted that the strain relief clamp 420 does not surround any portion of the mandrel 280 and thus exerts the second inwardly-directed radial force against an internally unsupported portion of the coaxial cable 100.

In at least some example embodiments, the first inwardly-directed radial force is less than the second inwardly-directed radial force. This difference in force may be due to differences in size and/or shape between the moisture seal 320 and the strain relief clamp 420, and/or due to differences in the deforming forces applied to the moisture seal 320 and the strain relief clamp 420. This difference in force may also, or alternatively, be due, at least in part, to the moisture seal 320 being formed from a material that is softer than the material from which the strain relief clamp 420 is formed. For example, the moisture seal 320 may be formed from a relatively soft rubber material while the strain relief clamp 420 may be formed from a relatively hard rubber material or an acetal homopolymer material.

The relative softness of the material from which the moisture seal 320 is formed enables the moisture seal 320 to substantially prevent moisture from entering the example connector 200. For example, even though the surface of the jacket 108 of the coaxial cable 100 may be scraped or pitted, or may have other surface deformities or irregularities, the relatively soft moisture seal 320 is able to substantially seal the surface of the jacket 108 against moisture. Further, even though the cable 100 may bend at the moisture seal 320, and thus further compress the portions of the moisture seal 320 at the inside of the bend while pulling away from the portion of the moisture seal 320 at the outside of the bend, the relatively soft moisture seal 320 enables the portion of the moisture seal 320 at the outside of the bend to expand and continue to seal the surface of the jacket 108 at the outside of the bend against moisture.

After termination and installation of the coaxial cable 100, on a cellular communications tower for example, the mechanical and electrical contacts between the conductors of the coaxial cable 100 and the compression connector 200 may be subject to strain due to, for example, high wind and vibration. The second inwardly-directed radial force exerted by the strain relief clamp 420 relieves strain on the coaxial cable 100 from being transferred to the mechanical and electrical contacts between the outer conductor 106, the clamp 300, and the mandrel 280.

In particular, the inclusion of the strain relief clamp 420, with its second inwardly-directed radial force, substantially prevents the coaxial cable 100 from flexing between the strain relief clamp 420 and the mechanical and electrical contacts between the outer conductor 106, the clamp 300, and the mandrel 280. Instead, the coaxial cable 100 is only allowed to flex beyond the strain relief clamp 420 opposite the clamp 300. Therefore, while the relatively lesser first inwardly-directed radial force exerted by the moisture seal 320 may allow strain on the coaxial cable 100 to be transferred past the moisture seal 320 into the example compression connector 200, the relatively greater inwardly-directed radial force exerted by the strain relief clamp 420 substantially prevents strain on the coaxial cable 100 from being transferred past the strain relief clamp 420 to the mechanical and electrical contacts between the outer conductor 106, the clamp 300, and the mandrel 280.

Further, the placement of the strain relief clamp 420 beyond the end of the mandrel 280 so that the strain relief clamp 420 does not surround any portion of the mandrel 280 enables the strain relief clamp 420 to provide greater strain relief than if the strain relief clamp 420 were surrounding some portion of the mandrel 280, and thereby necessarily placed closer to the clamp 300. In general, the further that the strain relief clamp 420 is placed from the clamp 300, the more strain relief is provided to the mechanical and electrical contacts between the outer conductor 106, the clamp 300, and the mandrel 280.

Substantially preventing strain on these mechanical and electrical contacts helps these contacts remain linear and secure, which helps reduce or prevent micro arcing or corona discharge between surfaces, which reduces the PIM levels and associated creation of interfering RF signals that emanate from the example compression connector 200. Advantageously, the example field-installable compression connector 200 exhibits PIM characteristics that match or exceed the corresponding characteristics of less convenient factory-installed soldered or welded connectors on pre-fabricated jumper cables.

### III. First Alternative Compression Connector Assembly

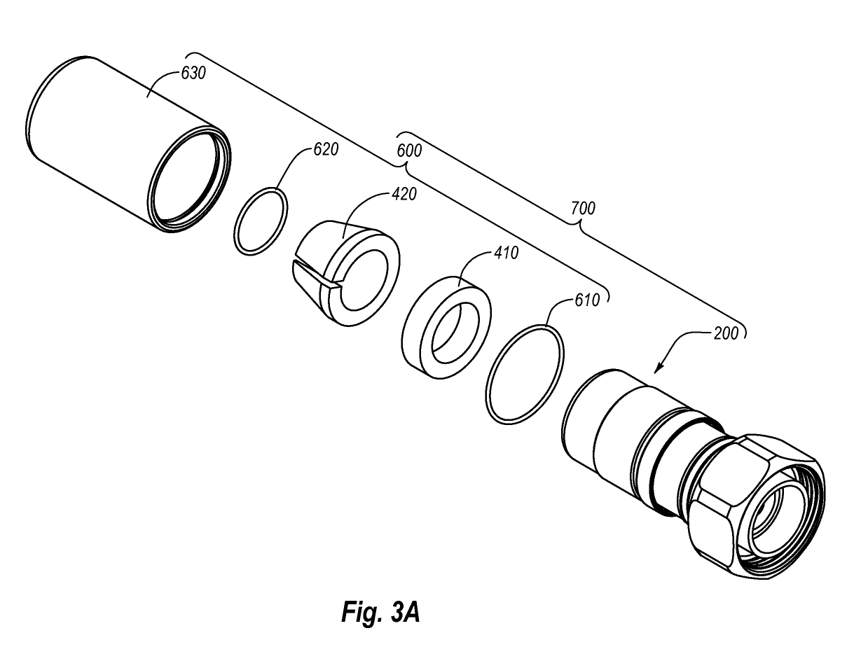

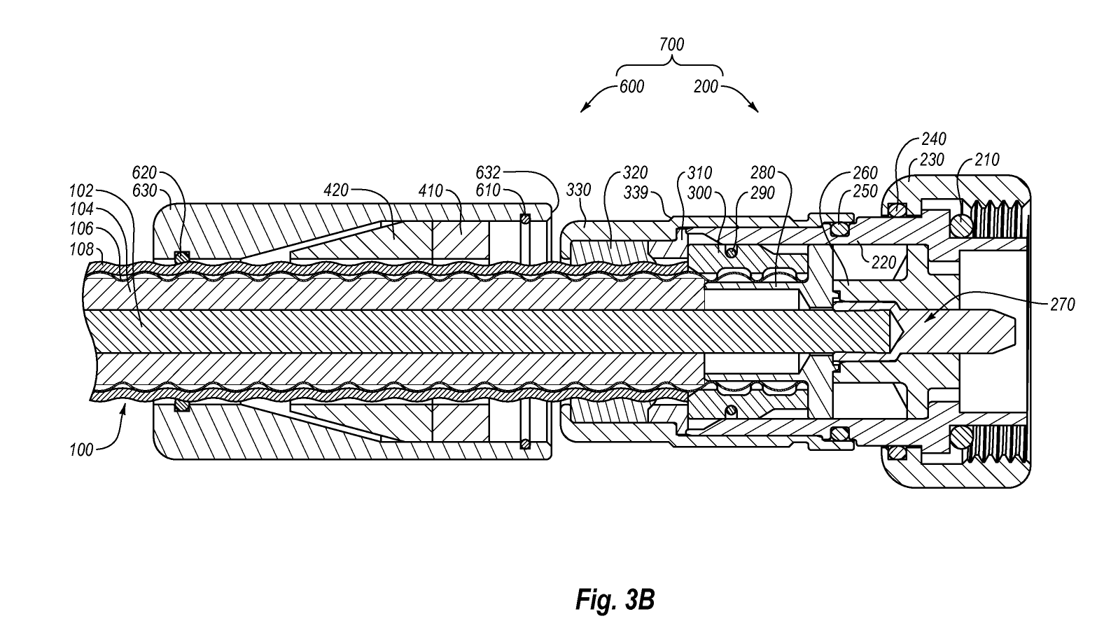

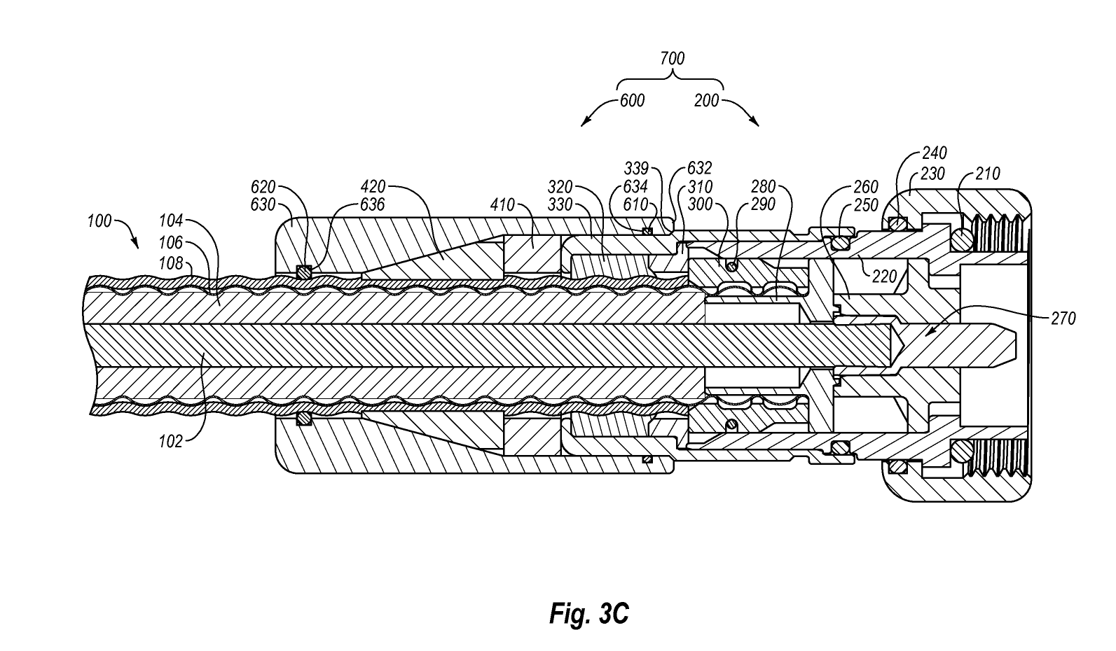

With reference now to FIGS. 3A-3C, a first alternative compression connector assembly 700 is disclosed. As disclosed in FIG. 3A, the first alternative compression connector assembly 700 includes the compression connector 200 and a first alternative strain relief accessory 600. The first alternative strain relief accessory 600 is identical to the strain relief accessory 400 except that the clamp sleeve 430 has been replaced with a clamp sleeve 630 and fourth and fifth o-ring seals 610 and 620 have been added to the first alternative strain relief accessory 600. As disclosed in FIG. 3B, the fourth and fifth o-ring seals 610 and 620 are positioned within the clamp sleeve 630.

With reference now to FIGS. 3B and 3C, aspects of the operation of the first alternative compression connector assembly 700 are disclosed. FIG. 3B discloses the example compression connector 200 after having been moved, during the first stage of a two-stage compression process, into an engaged position. FIG. 3C discloses the first alternative strain relief accessory 600 after having been moved, during the second stage of the two-stage compression process, into an engaged position. As most of the components of the first alternative compression connector assembly 700 are identical in form and function to the components of the example compression connector assembly 500, only those aspects of the operation the first alternative compression connector assembly 700 that differ from the operation the example compression connector assembly 500 are discussed below.

As disclosed in FIGS. 3B and 3C, during the second stage of the two-stage compression process, the first alternative strain relief accessory 600 is moved into the engaged position by sliding the clamp sleeve 630 axially along the compression sleeve 330 toward the connector nut 230 until the distal end 632 of the clamp sleeve 630 abuts a shoulder 339 of the compression sleeve 330.

Further, as the first alternative strain relief accessory 600 is moved into the engaged position during the second stage of the two-stage compression process, the compression sleeve 230 compresses the fourth o-ring seal 610 into an annular groove 634 defined in the clamp sleeve 630, thus sealing the clamp sleeve 630 to the compression sleeve 330. In addition, the fifth o-ring seal 620 is compressed by the jacket 108 of the coaxial cable 100 into an annular groove 636 defined in the clamp sleeve 630, thus sealing the clamp sleeve 630 to the jacket 108. The fourth and fifth o-ring seals 610 and 620 together function to prevent moisture from entering the first alternative strain relief accessory 600 through either open end of the clamp sleeve 630.

### IV. Second Alternative Compression Connector Assembly

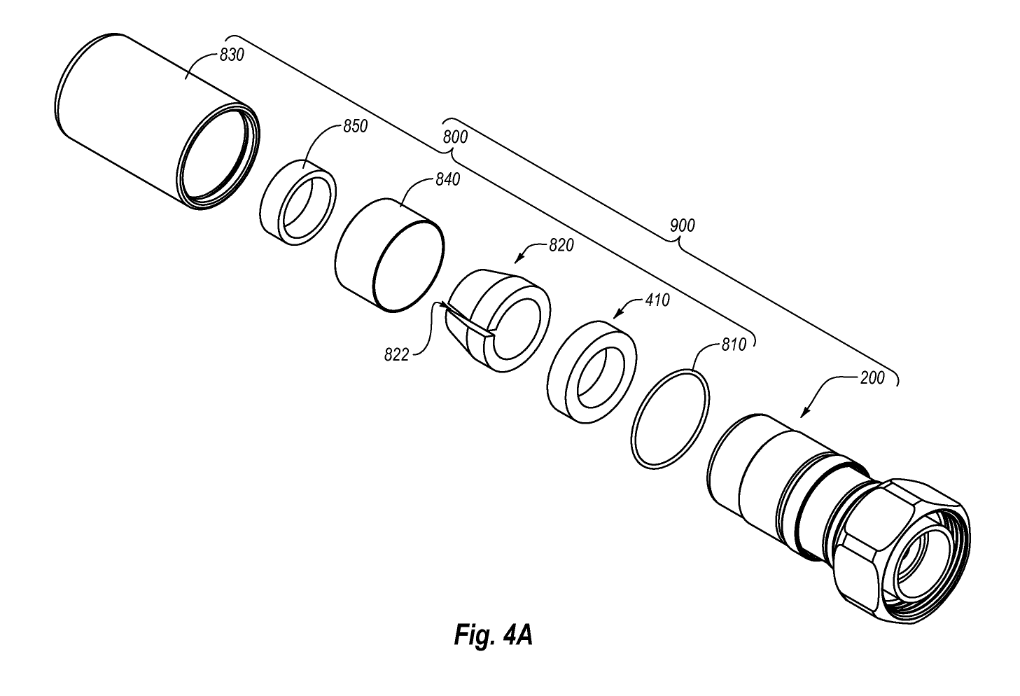

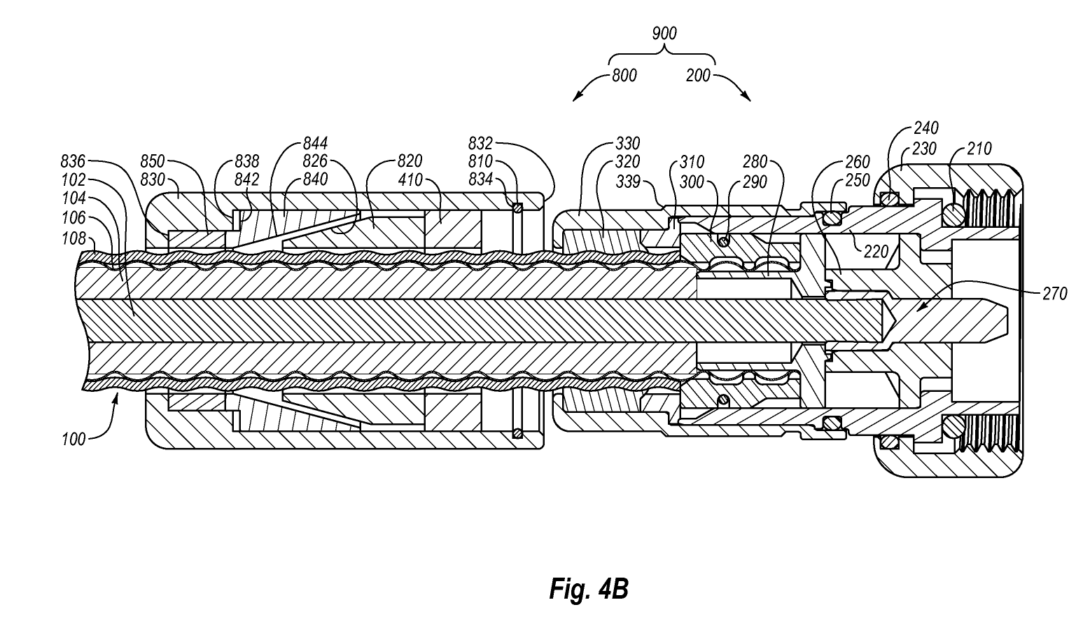

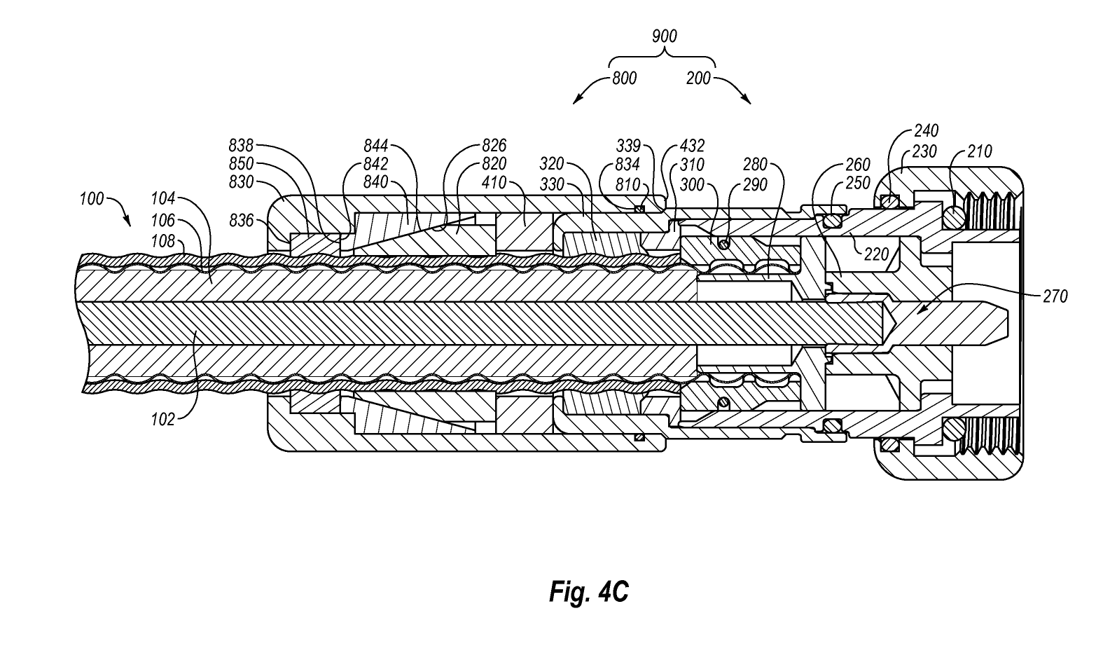

With reference now to FIGS. 4A-4C, a second alternative compression connector assembly 900 is disclosed. As disclosed in FIG. 4A, the second alternative compression connector assembly 900 includes the compression connector 200 and a second alternative strain relief accessory 800. The second alternative strain relief accessory 800 is identical to the strain relief accessory 400 except that the strain relief clamp 420 and the clamp sleeve 430 have been replaced with a strain relief clamp 820, and a clamp sleeve 830, a fourth o-ring seal 810, a clamp ring 840, and a second moisture seal 850 have been added to the second alternative strain relief accessory 800. As disclosed in FIG. 4B, the fourth o-ring seal 810, the strain relief clamp 820, the clamp ring 840, and the second moisture seal 850 are positioned within the clamp sleeve 830.

With reference now to FIGS. 4B and 4C, aspects of the operation of the second alternative compression connector assembly 900 are disclosed. FIG. 4B discloses the example compression connector 200 after having been moved, during the first stage of a two-stage compression process, into an engaged position. FIG. 4C discloses the second alternative strain relief accessory 800 after having been moved, during the second stage of the two-stage compression process, into an engaged position. As most of the components of the second alternative compression connector assembly 900 are identical in form and function to the components of the example compression connector assembly 500, only those aspects of the operation the second alternative compression connector assembly 900 that differ from the operation the example compression connector assembly 500 are discussed below.

As disclosed in FIGS. 4B and 4C, during the second stage of the two-stage compression process, the second alternative strain relief accessory 800 is moved into the engaged position by sliding the clamp sleeve 830 axially along the compression sleeve 330 toward the connector nut 230 until a distal end 832 of the clamp sleeve 830 abuts a shoulder 339 of the compression sleeve 330.

Further, as the second alternative strain relief accessory 800 is moved into the engaged position during the second stage of the two-stage compression process, the compression sleeve 330 compresses the fourth o-ring seal 810 into an annular groove 834 defined in the clamp sleeve 830, thus sealing the clamp sleeve 830 to the compression sleeve 330.

Also, as the second alternative strain relief accessory 800 is moved into the engaged position during the second stage of the two-stage compression process, a flange 836 of the clamp sleeve 830 axially biases against the second moisture seal 850, which axially biases against the clamp ring 840, which axially biases against the strain relief clamp 820, which axially biases against the clamp retention ring 410, which axially biases against the rear end of the compression sleeve 330. The axial force of the flange 836 of the clamp sleeve 830 combined with the opposite axial force of the clamp ring 840 axially compress the second moisture seal 850 until a shoulder 842 of the clamp ring abuts a shoulder 838 of the clamp sleeve 830, thus causing the second moisture seal 850 to become shorter in length and thicker in width. The thickened width of the second moisture seal 850 causes the second moisture seal 850 to exert a third inwardly-directed radial force against the jacket 108 of the coaxial cable 100, thus sealing the clamp sleeve 830 to the jacket 108. In at least some example embodiments, the third inwardly-directed radial force of the second moisture seal 850 is substantially equal to the first inwardly-directed radial force of the moisture seal 320.

The fourth o-ring seal 810 and the second moisture seal 850 together function to prevent moisture from entering the second alternative strain relief accessory 800 through either end of the clamp sleeve 830.

Further, as the second alternative strain relief accessory 800 is moved into the engaged position during the second stage of the two-stage compression process, the axial force of the clamp ring 840 combined with the opposite axial force of the clamp retention ring 410 forces a tapered surface 844 of the clamp ring 840 to interact with a corresponding tapered surface 826 of the strain relief clamp 820 in order to exert a second inwardly-directed radial force against the jacket 108 by narrowing or closing the slot 822 (see FIG. 2B). The tapered surface 826 of the strain relief clamp 820 tapers inwardly away from the example compression connector 200. It is noted that the strain relief clamp 820 does not surround any portion of the mandrel 280 and thus exerts the second inwardly-directed radial force against an internally unsupported portion of the coaxial cable 100.

In at least some example embodiments, the first inwardly-directed radial force is less than the second inwardly-directed radial force. This difference in force may be due to differences in size and/or shape between the moisture seal 320 and the strain relief clamp 820, and/or due to differences in the deforming forces applied to the moisture seal 320 and the strain relief clamp 820. This difference in force may also, or alternatively, be due, at least in part, to the moisture seal 320 being formed from a material that is softer than the material from which the strain relief clamp 820 is formed.

### V. Alternative Compression Connector Assemblies

It is understood that the order of the components disclosed in FIGS. 2A-4C may be altered in some example embodiments. For example, instead of the moisture seal 320 being included in the example compression connector 200 and being positioned between the strain relief clamp 420 and the clamp 300, the moisture seal 320 may instead be included in the clamp sleeve 430 and the strain relief clamp 420 may be positioned between the clamp 300 and the moisture seal 320.

In addition, it is also understood that, in at least some example embodiments, the moisture seal 320 and the strain relief clamp 420 may be integrally formed as a single part. For example, a single part may include a portion that functions as a moisture seal and another integral portion that functions as a strain relief clamp.

Further, although the engagement surface 424 of the strain relief clamp 420 is disclosed in FIGS. 2B-2E as a substantially smooth cylindrical surface, it is contemplated that portions of the engagement surface 424 may be non-cylindrical. For example, portions of the engagement surface 424 may include steps, grooves, ribs, or teeth in order better engage the jacket 108 of the coaxial cable 100.

In addition, the clamping functionality of the strain relief clamp 420 can be accomplished by strain relief clamps having other configurations. For example, alternative strain relief clamps can be tapered in the opposite direction, can include multiple tapered surfaces at different angles, can include opposing tapered surfaces that are configured to interact with corresponding opposing tapered surfaces of other components, can include multiple slots, or can include a thickness that enables the strain relief clamp to accommodate coaxial cables having significantly different outside diameters. In addition, two or more of the above strain relief clamps can be included in the strain relief accessories 400, 600, or 800 in order to further enhance the strain relief functionality of the strain relief accessories.

For example, the strain relief clamp(s) included in each of the strain relief accessories 400, 600, or 800 can be configured similarly to any of the strain relief clamp configurations disclosed in co-pending U.S. patent application Ser. No. 12/889,913, titled “COAXIAL CABLE CONNECTOR WITH STRAIN RELIEF CLAMP,” which is filed concurrently herewith and incorporated herein by reference in its entirety.

Further, although the strain relief clamp 420 disclosed in FIGS. 2B-4C substantially surrounds and engages the jacket 108, it is understood that the stripped portion of the jacket 108 may extend into at least a portion of the strain relief clamp 420. Accordingly, the strain relief clamp 420 may exert an inwardly-directed radial force against the coaxial cable 100 along the jacket 108, the outer conductor 106, or both the jacket 108 and the outer conductor 106.

Also, the clamp 300 disclosed in FIGS. 2B-2E is only one example of an outer conductor clamp. Likewise, the clamp portion 274 of the conductive pin 270 is only one example of an inner conductor clamp. It is understood that the strain relief clamp 420 disclosed in FIGS. 2B-4C can be employed in connection with various other types of internal conductor clamps and/or external conductor clamps. For example, although the clamp 300 generally requires that the coaxial cable 100 be prepared to have an exposed section of the corrugated outer conductor 106, the clamp 300 could instead be replaced with a clamp that is configured to achieve mechanical and electrical contact with a smoothed or even cylindrical section of the outer conductor 106.

Further, although the example compression connector 200 and the example strain relief accessories 400, 600, and 800 can be separate components that are not connected in any way until the second stage of the two-stage compression process as disclosed herein, it is understood the example compression connector 200 and any one of the example strain relief accessories 400, 600, and 800 can instead be pre-connected prior to the termination of the coaxial cable 100. For example, the distal end 432 of the clamp sleeve 430 may be slid over a slight portion of the compression sleeve 330 during initial assembly of the example compression connector assemblies 500, 700, or 900 so that the entire compression connector assembly can be slid onto a terminal end of the coaxial cable in a single motion. Further, where the example compression connector 200 and one of the example strain relief accessories 400, 600, or 800 are pre-connected, the clamp retention ring 410 may be omitted and the length of the clamp sleeve 430 may be shortened by the length of the clamp retention ring 410 since the compression sleeve 330 will serve to retain the strain relief clamp 420 within the clamp sleeve 430. Even in the non-pre-connected compression connector assemblies 500, 700, or 900 disclosed in FIGS. 2A-4C, the clamp retention ring 410 may be omitted and the length of the clamp sleeve 430 may be shortened where the functionality of the clamp retention ring 410 is not desired.

Finally, it is understood that although the example coaxial cable connector 200 and the example strain relief accessories 400, 600, and 800 disclosed in the drawings are engaged using a two-stage compression process using a separate compression tool, the strain relief clamp 420 and conductor clamps 300 and 274 can be beneficially employed in a similar connector and a similar strain relief accessory in which the connector and the strain relief accessory are engaged using screw mechanisms that are built into the connector and the strain relief accessory.

The example embodiments disclosed herein may be embodied in other specific forms. The example embodiments disclosed herein are to be considered in all respects only as illustrative and not restrictive.

What is claimed is:

1. A strain relief accessory for a coaxial cable connector, the strain relief accessory comprising:
a clamp sleeve configured to surround a coaxial cable and attach to the rear end of a coaxial cable connector; and
a strain relief clamp positioned within the clamp sleeve and configured to exert an inwardly-directed radial force against the coaxial cable.

2. The strain relief accessory as recited in claim 1, wherein the strain relief clamp includes a tapered surface configured to interact with a corresponding tapered surface of the clamp sleeve in order to exert the inwardly-directed radial force against the coaxial cable.

3. The strain relief accessory as recited in claim 2, wherein the tapered surface of the strain relief clamp tapers inwardly away from the coaxial cable connector.

4. The strain relief accessory as recited in claim 1, wherein the clamp sleeve is configured to attach to the rear end of the coaxial cable connector by being forced to slide onto the rear end of the coaxial cable connector and thereby surround the rear end of the coaxial cable connector in an interference fit engagement.

5. The strain relief accessory as recited in claim 1, wherein an engagement surface of the strain relief clamp includes teeth.

6. The strain relief accessory as recited in claim 1, further comprising first and second seals on either side of the strain relief clamp that are configured to seal the clamp sleeve to the rear end of a coaxial cable connector and the clamp sleeve to the coaxial cable, respectively.

7. A strain relief accessory for a coaxial cable connector, the strain relief accessory comprising:
a clamp sleeve configured to surround a coaxial cable and attach to the rear end of a coaxial cable connector;
a strain relief clamp positioned within the clamp sleeve and configured to exert an inwardly-directed radial force against the coaxial cable; and
a clamp retention ring configured to retain the strain relief clamp within the clamp sleeve.

8. The strain relief accessory as recited in claim 7, wherein the clamp retention ring engages an inside surface of the clamp sleeve via an interference fit.

9. The strain relief accessory as recited in claim 7, wherein the clamp sleeve is configured to attach to the rear end of the coaxial cable connector by being forced to slide onto the rear end of the coaxial cable connector and thereby surround the rear end of the coaxial cable connector in an interference fit engagement.

10. The strain relief accessory as recited in claim 9, wherein during attachment of the clamp sleeve to the rear end of the coaxial cable connector, the clamp retention ring is configured to make direct physical contact with the coaxial cable connector.

11. The strain relief accessory as recited in claim 10, wherein during attachment of the clamp sleeve to the rear end of the coaxial cable connector, the clamp retention ring is further configured to make direct physical contact with the strain relief clamp.

12. The strain relief accessory as recited in claim 7, wherein the strain relief clamp includes a tapered surface configured to interact with a corresponding tapered surface of the clamp sleeve in order to exert the inwardly-directed radial force against the coaxial cable.

13. The strain relief accessory as recited in claim 7, further comprising first and second seals on either side of the strain relief clamp that are configured to seal the clamp sleeve to the rear end of a coaxial cable connector and the clamp sleeve to the coaxial cable, respectively.

14. The strain relief accessory as recited in claim 7, wherein an engagement surface of the strain relief clamp includes teeth.

15. A coaxial cable connector assembly for terminating a coaxial cable, the coaxial cable comprising an inner conductor, an insulating layer surrounding the inner conductor, an outer conductor surrounding the insulating layer, and a jacket surrounding the outer conductor, the coaxial cable connector assembly comprising:
a coaxial cable connector comprising:
an inner conductor clamp configured to engage the inner conductor;
an outer conductor clamp configured to compress the outer conductor against an internal support structure; and
a moisture seal configured to engage the jacket; and
a strain relief accessory comprising a strain relief clamp configured to engage the coaxial cable, the strain relief clamp not surrounding any portion of the internal support structure.

16. The coaxial cable connector assembly as recited in claim 15, wherein the moisture seal is positioned between the outer conductor clamp and the strain relief clamp.

17. The coaxial cable connector assembly as recited in claim 15, wherein:
the moisture seal is configured to exert a first inwardly-directed radial force against the jacket; and
the strain relief clamp is configured to exert a second inwardly-directed radial force against the coaxial cable, the first force being less than the second force.

18. The coaxial cable connector assembly as recited in claim 15, wherein the coaxial cable connector is configured to be moved from an open position to an engaged position using a screw mechanism.

19. The coaxial cable connector assembly as recited in claim 15, wherein:
the coaxial cable connector is configured to be moved from an open position to an engaged position in a first compression operation; and
the strain relief accessory is configured to be moved from an open position to an engaged position in a second compression operation.

20. A terminated coaxial cable comprising:
a coaxial cable comprising:
an inner conductor;
an insulating layer surrounding the inner conductor;
an outer conductor surrounding the insulating layer; and
a jacket surrounding the outer conductor; and
a coaxial cable connector assembly as recited in claim 15 attached to a terminal section of the coaxial cable.
